(19) United States
(12) Patent Application Publication
(10) Pub. No.: US 2002/0034026 A1
(43) Pub. Date: Mar. 21, 2002

(54) Molded packages for optical wireless network micromirror assemblies

(76) Inventors: John W. Orcutt, Richardson, TX (US); Bruce Simpson, Celina, TX (US); Arthur M. Turner, Allen, TX (US)

Correspondence Address: TEXAS INSTRUMENTS INCORPORATED, P O BOX 655474, M/S 3999, DALLAS, TX, 75265

(21) Appl. No.: 09/955,506

(22) Filed: Sep. 18, 2001

Related U.S. Application Data
(60) Provisional application No. 60/234,074, filed on Sep. 20, 2000.

(51) Int. Cl. G02B 7/182

(52) U.S. Cl. 359/877

(57) ABSTRACT

A packaged micromirror assembly (10, 10′, 10″, 110) is disclosed. The assembly (10, 10′, 10″, 110) includes a mirror element (41) having a mirror surface (29) that can rotate in two axes. Magnets (53) are attached to the mirror element (41), to permit rotation of the mirror surface (29). Coil drivers (36) are attached to a circuit board (38) or to a lead frame (65, 65′). A plastic body (30, 70) is formed around the coil drivers (36) to have an upper surface with an inner shelf (34, 74) to which the mirror element (41) is attached, and an outer shelf (32, 72) to which a transparent window (31) is attached. A resistance heater (80) may be included within the body (30, 70) to prevent internal condensation in harsh environments. Alternative embodiments of the molded assembly (120, 150) include electrostatic plates (145, 146; 155, 156) that mate with widened gimbal portions (135, 136) of the mirror element (130) to electrostatically deflect the mirror surface (124). The disclosed packages (10, 10′, 10″, 110) permit volume production of micromirror assemblies as useful in a communications network.

### CROSS-REFERENCE TO RELATED APPLICATIONS

This application claims priority, under 35 U.S.C. §119(e), of provisional application No. 60/234,074, filed Sep. 20, 2000.

### STATEMENT REGARDING FEDERALLY SPONSORED RESEARCH OR DEVELOPMENT

Not applicable.

### BACKGROUND OF THE INVENTION

This invention is in the field of optical communications, and is more specifically directed to packaging of micromirror assemblies as used in such communications.

Modern data communications technologies have greatly expanded the ability to communicate large amounts of data over many types of communications facilities. This explosion in communications capability not only permits the communications of large databases, but has also enabled the digital communications of audio and video content. This high bandwidth communication is now carried out over a variety of facilities, including telephone lines (fiber optic as well as twisted-pair), coaxial cable such as supported by cable television service providers, dedicated network cabling within an office or home location, satellite links, and wireless telephony.

Each of these conventional communications facilities involves certain limitations in their deployment. In the case of communications over the telephone network, high-speed data transmission, such as that provided by digital subscriber line (DSL) services, must be carried out at a specific frequency range to not interfere with voice traffic, and is currently limited in the distance that such high-frequency communications can travel. Of course, communications over “wired” networks, including the telephone network, cable network, or dedicated network, requires the running of the physical wires among the locations to be served. This physical installation and maintenance is costly, as well as limiting to the user of the communications network.

Wireless communication facilities of course overcome the limitation of physical wires and cabling, and provide great flexibility to the user. Conventional wireless technologies involve their own limitations, however. For example, in the case of wireless telephony, the frequencies at which communications may be carried out are regulated and controlled; furthermore, current wireless telephone communication of large data blocks, such as video, is prohibitively expensive, considering the per-unit-time charges for wireless services. Additionally, wireless telephone communications are subject to interference among the various users within the nearby area. Radio frequency data communication must also be carried out within specified frequencies, and is also vulnerable to interference from other transmissions. Satellite transmission is also currently expensive, particularly for bi-directional communications (i.e., beyond the passive reception of television programming).

A relatively new technology that has been proposed for data communications is the optical wireless network. According to this approach, data is transmitted by way of modulation of a light beam, in much the same manner as in the case of fiber optic telephone communications. A photoreceiver receives the modulated light, and demodulates the signal to retrieve the data. As opposed to fiber optic-based optical communications, however, this approach does not use a physical wire for transmission of the light signal. In the case of directed optical communications, a line-of-sight relationship between the transmitter and the receiver permits a modulated light beam, such as that produced by a laser, to travel without the waveguide of the fiber optic.

It is contemplated that the optical wireless network according to this approach will provide numerous important advantages. First, high frequency light can provide high bandwidth, for example ranging from on the order of 100 Mbps to several Gbps, using conventional technology. This high bandwidth need not be shared among users, when carried out over line-of-sight optical communications between transmitters and receivers. Without the other users on the link, of course, the bandwidth is not limited by interference from other users, as in the case of wireless telephony. Modulation can also be quite simple, as compared with multiple-user communications that require time or code multiplexing of multiple communications. Bi-directional communication can also be readily carried out according to this technology. Finally, optical frequencies are not currently regulated, and as such no licensing is required for the deployment of extra-premises networks.

These attributes of optical wireless networks make this technology attractive both for local networks within a building, and also for external networks. Indeed, it is contemplated that optical wireless communications may be useful in data communication within a room, such as for communicating video signals from a computer to a display device, such as a video projector.

It will be apparent to those skilled in the art having reference to this specification that the ability to correctly aim the transmitted light beam to the receive is of importance in this technology. Particularly for laser-generated beams, which have quite small spot sizes, the reliability and signal-to-noise ratio of the transmitted signal are degraded if the aim of the transmitting beam strays from the optimum point at the receiver. Especially considering that many contemplated applications of this technology are in connection with equipment that will not be precisely located, or that may move over time, the need exists to precisely aim and controllably adjust the aim of the light beam.

Copending application Ser. No. 09/310,284, filed May 12, 1999, entitled “Optical Switching Apparatus”, commonly assigned herewith and incorporated herein by this reference, discloses a micromirror assembly for directing a light beam in an optical switching apparatus. As disclosed in this application, the micromirror reflects the light beam in a manner that may be precisely controlled by electrical signals. As disclosed in this patent application, the micromirror assembly includes a silicon mirror capable of rotating in two axes. One ore more small magnets are attached to the micromirror itself; a set of four coil drivers are arranged in quadrants, and are current-controlled to attract or repel the micromirror magnets as desired, to tilt the micromirror in the desired direction. Also as disclosed in this patent application, the micromirror assembly is housed in a hermetic package.

### BRIEF SUMMARY OF THE INVENTION

It is therefore an object of the present invention to provide a relatively low-cost package for a micromirror assembly.

It is a further object of the present invention to provide a method for making such a package.

It is a further object of the present invention to provide such a low-cost package and method that is well suited for high-volume production.

Other objects and advantages of the present invention will be apparent to those of ordinary skill in the art having reference to the following specification together with its drawings.

The present invention may be implemented into a package for a micromirror assembly. The package is molded around a plurality of coil drivers, and their control wiring, for example by injection or transfer molding. A two-axis micromirror and magnet assembly is attached to a shelf overlying the coil drivers. A second shelf receives a protective window over the micromirror assembly.

According to one aspect of the invention, the coil magnets are mounted to a board assembly, around which the plastic is cast or potted. According to another aspect of the invention, the coil drivers are mounted to a lead frame, around which transfer molding forms the package.

### BRIEF DESCRIPTION OF THE SEVERAL VIEWS OF THE DRAWING

FIG. 1 is a schematic drawing of an optical wireless network using the packaged micromirror assembly according to the preferred embodiments of the invention.

FIGS. 2a through 2e are various plan, perspective, and cross-sectional views of a packaged micromirror assembly according to a first preferred embodiment of the invention.

FIG. 3 is a plan view of a mirror element in the packaged micromirror assembly according to the first preferred embodiment of the invention.

FIGS. 3a through 3d are cross-sectional views of the mirror element of FIG. 3, illustrating its operation.

FIGS. 4a through 4e are cross-sectional views illustrating the packaged micromirror assembly of FIGS. 2a and 2b in its stages of manufacture according to the first preferred embodiment of the invention.

FIGS. 5a and 5b are cross-sectional views of packaged micromirror assemblies according to a second preferred embodiment of the invention.

FIGS. 6a through 6c are cross-sectional views illustrating the packaged micromirror assembly of FIGS. 5a and 5b in its stages of manufacture according to the second preferred embodiment of the invention.

FIG. 7 is a cross-sectional view of a packaged micromirror assembly according to a third preferred embodiment of the invention.

FIGS. 8a and 8b are plan views of a mirror element and electrostatic plates, respectively, for use in a packaged mirror assembly according to a fourth preferred embodiment of the invention.

FIG. 8c is a cross-sectional view of a packaged micromirror assembly according to the fourth preferred embodiment of the invention.

FIG. 9a is a plan view of a lead frame for a molded micromirror assembly package according to a fifth preferred embodiment of the invention.

FIG. 9b is a cross-sectional view of the molded micromirror assembly package according to the fifth preferred embodiment of the invention.

### DETAILED DESCRIPTION OF THE INVENTION

The present invention will be described in connection with its preferred embodiments, with an example of an application of these preferred embodiments in a communications network. It is contemplated, however, that the present invention may be realized not only in the manner described below, but also by way of various alternatives which will be apparent to those skilled in the art having reference to this specification. It is further contemplated that the present invention may be advantageously implemented and used in connection with a variety of applications besides those described below. It is therefore to be understood that the following description is presented by way of example only, and that this description is not to be construed to limit the true scope of the present invention as hereinafter claimed.

Referring first to FIG. 1, an example of an optical wireless network will be illustrated, to provide context for the present invention. In this simple example, unidirectional communications are to be carried out from computer 2 to server 20, by way of modulated directed light. In this example, computer 2 is a conventional microprocessor based personal computer or workstation, including the appropriate network interface adapter for outputting the data to be communicated. Computer 2 is connected to transmitter optical module 5, which aims a directed light beam at the desired receiver 17, and which modulates the light beam to communicate the data.

In this example, transmitter optical module 5 includes modulating laser 6, which generates a collimated coherent light beam of the desired wavelength (e.g., 850 nm) and power (e.g., on the order of 4/5 μW/cm² measured at 50 meters, with a spot size of on the order of 2.0 to 2.5 mm in diameter). Modulating laser 6 modulates this light beam according to the digital data being transmitted. The modulation scheme used preferably follows a conventional data communications standard, such as those used in connection with fiber optic communications for similar networks. The modulated laser beam exits modulating laser 6 and is reflected from micromirror assembly 10 toward receiver 17. The construction of micromirror assembly 10 according to the preferred embodiments of the invention will be described in further detail below.

The reflected laser beam impinges beam splitter 12, in this example. Beam splitter 12 transmits the majority of the energy to receiver 17, but reflects a portion of the energy to position sensitive detector (PSD) 15. PSD 15 provides signals to control circuitry 14, indicating the position of the reflected light that it receives. Control circuitry 14 then issues control signals to micromirror assembly 10 to direct its angle of reflection in response to the signals from PSD 15, to optimize the aim of the directed laser beam at receiver 17. In one example, during setup of the transmission, micromirror assembly 10 and PSD 15 “sweeps” the aim of the directed laser beam across the general area of receiver 17. In response, receiver 17 issue signals to control circuitry 14 over a secondary communications channel (not shown), indicating the received energy over time. These “pings” may be compared with the instantaneous position of micromirror assembly 10 as measured by PSD 15, to calibrate and optimize the aim of micromirror assembly 10 to achieve maximum energy transmission. Once this aim is set, communications may then be carried out. It is contemplated, however, that adjustments may be necessary due to external factors such as building or equipment movement and the like. These adjustments may be carried out by way of feedback from receiver 17 (either over the secondary channel or as transmit mode feedback in a duplex arrangement), or by periodically repeating the measurement and sweeping.

On the receiver end, receiver 17 captures the incoming directed light beam, and converts the modulated light energy to an electrical signal; for example, receiver 17 may include a photodiode, which modulates an electrical signal in response to the intensity of detected light. Such other conventional receiver circuitry, such as demodulators, filters, and the line, are also provided. The demodulated communicated electrical signal is then forwarded from receiver 17 to router 18, and thus into the receiving network, for eventual distribution to server 20, in this example.

As evident from FIG. 1 and the foregoing description, this example illustrates a unidirectional, or simplex, communications approach, for ease of this description. It will be appreciated by those skilled in the art that bi-directional, or duplex, communications may be carried out by providing another transmitter-receiver pair for communicating signals in the opposite direction (router 18 to computer 2).

The communications arrangement of FIG. 1 may be utilized in connection with a wide range of applications, beyond the simple computer-to-network example suggested by FIG. 1. For example, it is contemplated that each of multiple computers in an office or other workspace may communicate with one another and with a larger network by way of modulated light to a central receiver within the room, and also between rooms by way of relayed communications along hallways or in a space frame. Other indoor applications for this optical wireless communications may include the communication of video signals from a computer or DVD player to a large-screen projector. It is further contemplated that optical wireless communications in this fashion may be carried out in this manner but on a larger scale, for example between or among buildings.

According to the preferred embodiments of the present invention, the packaging of micromirror assembly 10 is particularly well-suited for widespread deployment in these, and other, applications, especially considering the relatively low cost and high reliability provided by these packages.

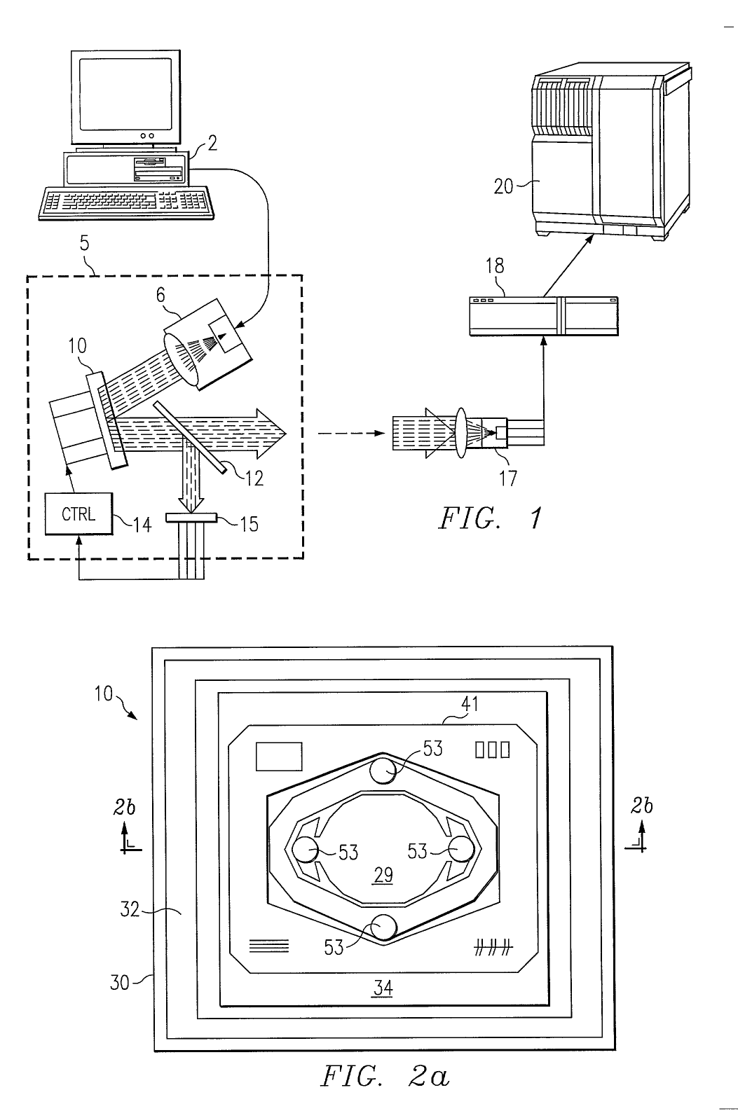

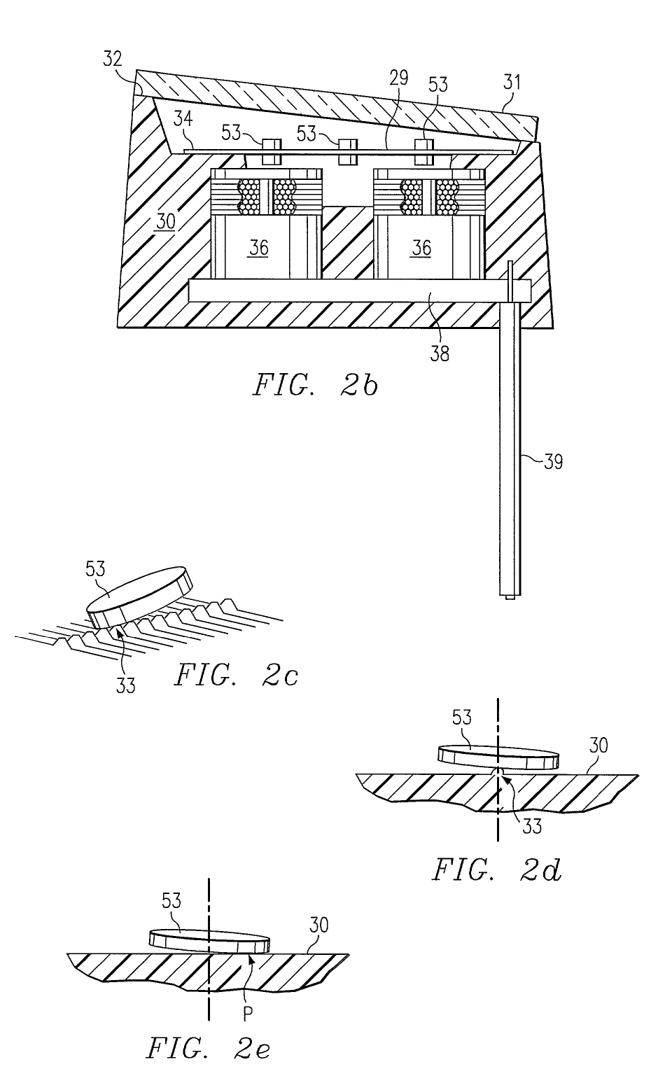

Referring now to FIGS. 2a and 2b, packaged micromirror assembly 10 according to a first preferred embodiment of the invention will now be described. As shown in FIGS. 2a and 2b and as will be described in further detail below, mirror element 41 is formed of a single piece of material, preferably single-crystal silicon, photolithographically etched in the desired pattern, to form mirror surface 29 and its supporting hinges and frame. To improve the reflectivity of mirror surface 29, mirror element 41 is preferably plated with a metal, such as gold or aluminum. In its assembled form, as shown in FIGS. 2a and 2b, four permanent magnets 53 are attached to mirror element 41, at a 90° relative orientation from one another, to provide the appropriate rotation. Magnets 53 may be formed of any permanently magnetizable material, a preferred example of which is neodymium-iron-boron.

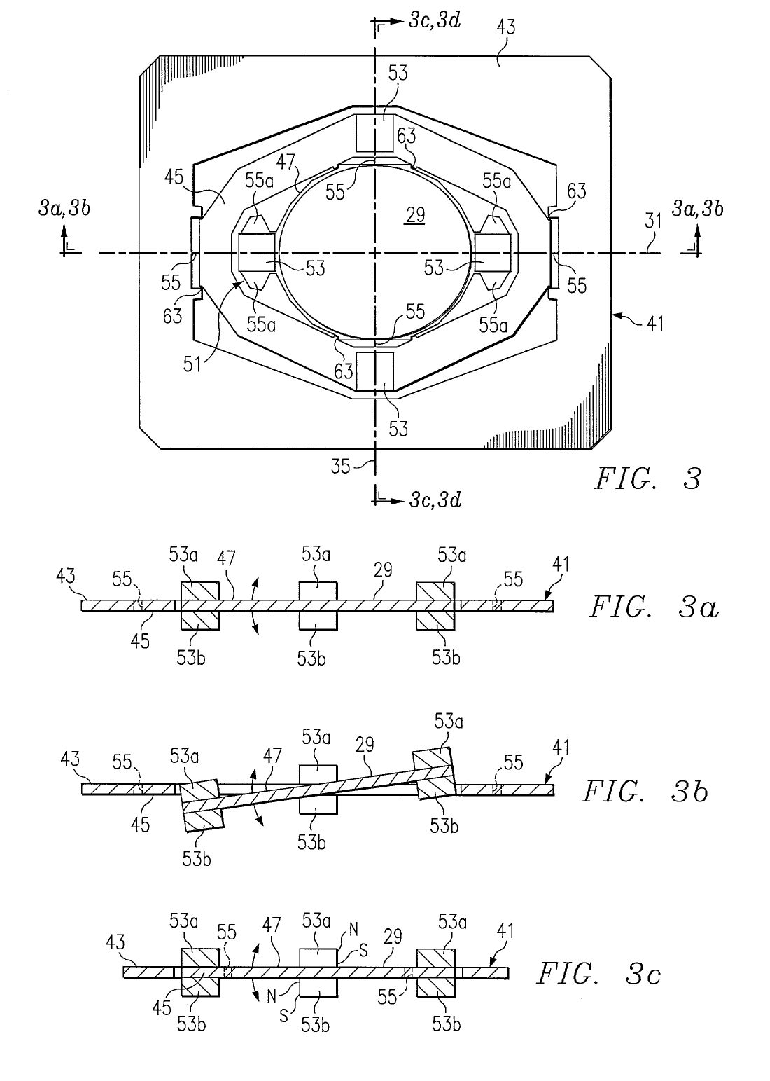

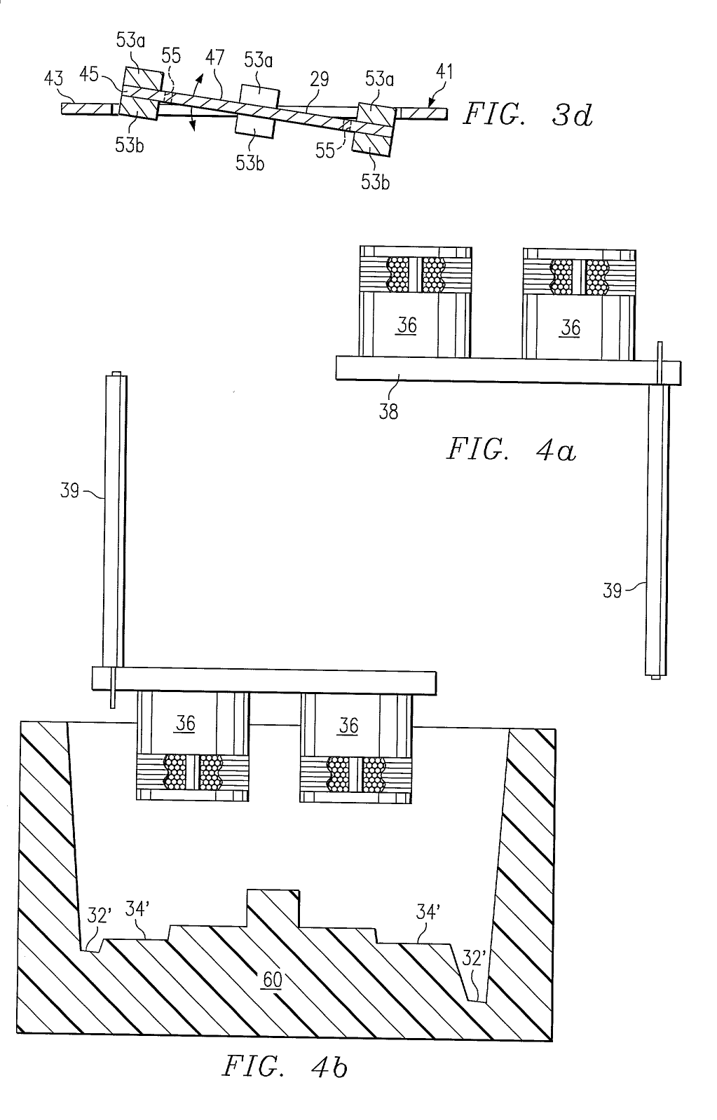

FIGS. 3 and 3a through 3d illustrate mirror element 41 in further detail. Mirror element 41 includes a frame portion, an intermediate gimbals portion, and an inner mirror portion, all preferably formed from one piece of crystal material such as silicon. In its fabrication, silicon is etched to provide outer frame portion 43 forming an opening in which intermediate annular gimbals portion 45 is attached at opposing hinge locations 55 along first axis 31. Inner, centrally disposed mirror portion 47, having a mirror 29 centrally located thereon, is attached to gimbals portion 45 at hinge portions 55 on a second axis 35, 90 degrees from the first axis. Mirror 29, which is on the order of 100 microns in thickness, is suitably polished on its upper surface to provide a specular surface. Preferably, this polished surface is plated with a metal, such as aluminum or gold, to provide further reflectivity. In order to provide necessary flatness, the mirror is formed with a radius of curvature greater than approximately 2 meters, with increasing optical path lengths requiring increasing radius of curvature. The radius of curvature can be controlled by known stress control techniques such as, by polishing on both opposite faces and deposition techniques for stress controlled thin films. If desired, a coating of suitable material can be placed on the mirror portion to enhance its reflectivity for specific radiation wavelengths.

Mirror element 41 includes a first pair of permanent magnets 53 mounted on gimbals portion 45 along the second axis, and a second pair of permanent magnets 53 mounted on extensions 51, which extend outwardly from mirror portion 47 along the first axis. In order to symmetrically distribute mass about the two axes of rotation to thereby minimize oscillation under shock and vibration, each permanent magnet 53 preferably comprises a set of an upper magnet 53a mounted on the top surface of the mirror element 41 using conventional attachment techniques such as indium bonding, and an aligned lower magnet 53b similarly attached to the lower surface of the mirror assembly as shown in FIGS. 3a through 3d. The magnets of each set are arranged serially such as the north/south pole arrangement indicated in FIG. 3c. There are several possible arrangements of the four sets of magnets which may be used, such as all like poles up, or two sets of like poles up, two sets of like poles down; or three sets of like poles up, one set of like pole down, depending upon magnetic characteristics desired.

By mounting gimbals portion 45 to frame portion 43 by means of hinges 55, motion of the gimbals portion 45 about the first axis 31 is provided and by mounting mirror portion 47 to gimbals portion 45 via hinges 55, motion of the mirror portion relative to the gimbals portion is obtained about the second axis 35, thereby allowing independent, selected movement of the mirror portion 47 along two different axes.

The middle or neutral position of mirror element 41 is shown in FIG. 3a, which is a section taken through the assembly along line A-A of FIG. 3. Rotation of mirror portion 47 about axis 35 independent of gimbals portion 45 and/or frame portion 43 is shown in FIG. 3b as indicated by the arrow. FIG. 3c shows the middle position of the mirror element 41, similar to that shown in FIG. 3a, but taken along line B-B of FIG. 3. Rotation off the gimbals portion 45 and mirror portion 47 about axis 31 independent of frame portion 43 is shown in FIG. 3d as indicated by the arrow. The above independent rotation of mirror 29 of mirror portion 47 about the two axes allows direction of optical beam 13 as needed by the optical switch units.

In order to protect hinges 55 from in-plane shock during handling and shipping, stops 57 may be provided, as described in the above-incorporated application Ser. No. 09/310,284. According to another optional feature of the invention, lock down tabs associated with each hinge are provided, also as described in the above-incorporated application Ser. No. 09/310,284.

Referring back to FIG. 3, extensions 51 are preferably provided with laterally extending tabs 51a, which can be used to clamp down the mirror portion during assembly to thereby provide additional stress protection.

Mirror element 41, in this embodiment of the invention, rests upon and is attached to shelf 34 of body 30. Shelf 34 lies inwardly of window shelf 32, upon which transparent window 31 rests and is attached. Window 31 may be formed of conventional microscope slide glass, or of a transparent plastic such as LEXAN plastic. It is highly preferred that the dimensions and locations of shelves 32, 34, as well as the bottom well of body 30, be selected so that the maximum deflection of mirror 29 is stopped by one of magnets 53 impacting body 30 without mirror 29 itself impacting the inner surface of window 31. Additionally, it is preferred that the maximum deflection of mirror 29 is limited, by body 30, to an angle that is well below that which overstresses hinges 55.

Referring now to FIGS. 2c and 2d, additional features of body 30 according to this first preferred embodiment of the invention will now be described. According to the preferred embodiment of the invention, the surface of body 30 includes stops 33 at its upper surface, at locations corresponding to those that will be impacted by the underside of mirrors 53, as shown in FIG. 2c. These stops 33 thus define the maximum deflection of mirror 29 which, as noted above, is preferably designed to limit the rotation of mirror 29 so as not to overstress hinges 55 and to not impact window 31. Stops 33 are defined by corresponding recesses in the mold used to define body 30 (as will be described below).

In addition to providing a reliable limit on the travel of mirror 29, stops 53 also prevent magnets 53 from contacting body 30 at an off-center location, as illustrated in FIGS. 2d and 2e. FIG. 2d illustrates magnet 53 impacting body 30 at a stop 33, as described above. As shown in FIG. 2d, the point of contact between magnet 53 is at its center line C/L, because stop 33 extends above the upper surface of body 30. In the absence of stops 33, the point of contact between magnet 53 is off-center, which causes an unwanted twisting moment on hinges 55, as well as possibly setting up oscillations in mirror element 41; this situation is shown in FIG. 2e, by point of contact P being away from center line C/L. By providing stops 33 as shown in FIGS. 2c and 2d, these undesired effects are avoided.

Disposed within body 30 are coil drivers 36, which are externally wound electromagnets about a corresponding bobbin, and aligned with a corresponding one of magnets 53. Because of the cross-sectional view of FIG. 2b, only two coil drivers 36 are illustrated; however, two more coil drivers 36 are similarly provided within micromirror assembly 10, so that each of the four magnets 53 has an associated coil driver 36 embedded within body 30. The bobbin of each coil driver 36 is preferably made of suitable material for the desired properties of heat transfer, magnetic dampening, and strength, for example liquid clear polymer or aluminum. Each bobbin is wound with highly conductivity wire such as copper. Each coil driver preferably has an air coil disposed as close to its corresponding magnet 53 as possible, for example, 200 microns, to provide full mirror rotation using minimum power. Coil drivers 36 are each electrically connected to driver circuit board 38 by way of wires (not shown in FIG. 2b), which in turn has external pins 39 (only one of which is visible in FIG. 2b) to provide external electrical connection to coil drivers 39. Pins 39 may be conventional integrated circuit package pins as shown, for mounting through holes in a circuit board; alternatively, pins 39 may be of the surface mount type.

As evident from this description of the preferred embodiment of the invention, magnets 53 are placed on mirror assembly 41 to balance the magnet mass. Alternatively, if a single magnet is used, it is preferably located coaxially with the center of mirror 29 to similarly balance the mass.

In operation, electrical signals communicated via pins 39 are applied to coil drivers 36, to control each coil driver 36 to generate a magnetic field of the desired polarity and magnitude. The magnetic field generated by each coil driver 36 either attracts or repels its associated magnet 53 mounted to mirror element 41, causing a net torque on mirror 29, as illustrated in FIGS. 3a through 3d. Proper control of the current applied to the set of coil drivers 36 orients mirror 29 in the desired direction, with a high degree of precision.

Body 30, according to this first preferred embodiment of the invention, is formed of a plastic material cast around coil drivers 36 and driver circuit board 38. This plastic material both facilitates the manufacture of micromirror assembly 10, and also provides a high reliability package for structural and environmental protection of the precision components in assembly 10. A preferred material for body 30 in this embodiment of the invention is a filled two-part epoxy, such as T905 or T7110 epoxy, available from Epoxy Technology. Alternatively, a cured rubber or a soft plastic may be used as the material of body 30; such a soft material can absorb the impact of mirror element 41 striking body 30, reducing the likelihood of mirror breakage.

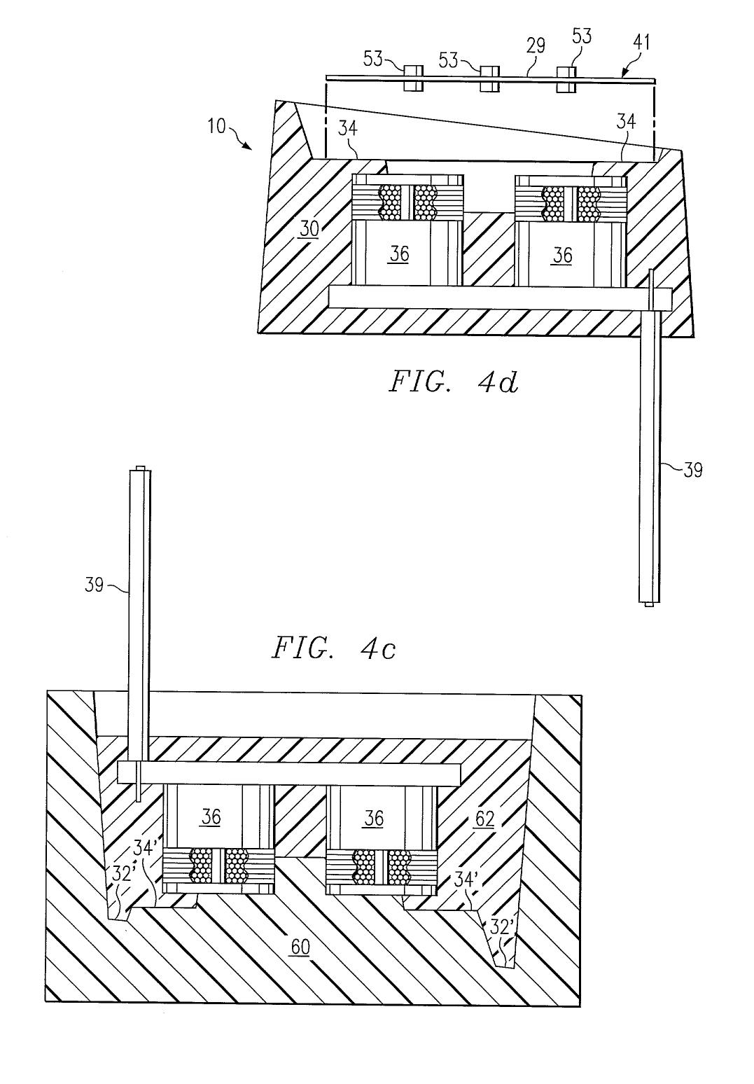

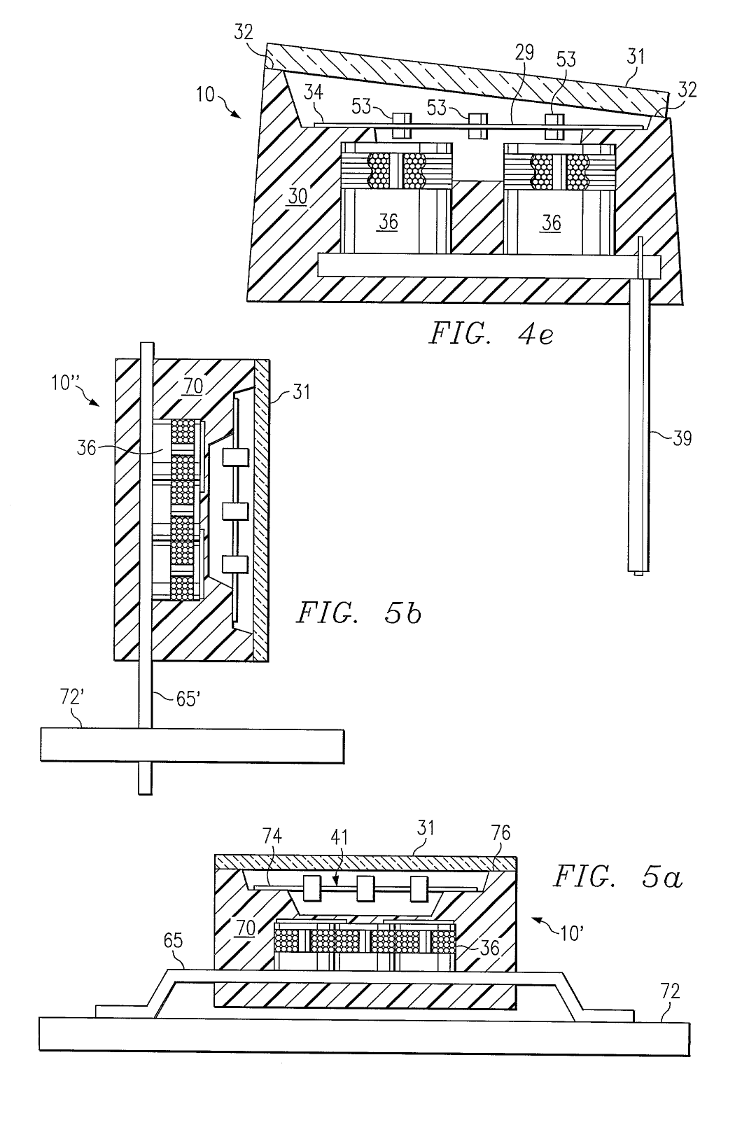

Referring now to FIGS. 4a through 4e, the construction of micromirror assembly 10 according to this first preferred embodiment of the present invention will now be described. According to this embodiment of the invention, the fabrication begins with the attachment of coil drivers 36 onto driver circuit board 38, and their electrical connection to pins 39. The result of this operation is illustrated in FIG. 4a.

As shown in FIG. 4b, driver circuit board 38 is then placed into mold 60, which may be fabricated from rubber or other conventional mold material. The interior shape of mold 60 is formed to include surfaces 32′, 34′ that will form shelves 32, 34, respectively, as well as to form the remainder of the eventual package. Recesses (not shown) are also preferably formed in mold 60 to form stops 33 as described above relative to FIGS. 2c and 2d. In order for best magnetic coupling, the surfaces of coil drivers 36 preferably abut corresponding surfaces of mold 60, so that coil drivers 36 will not be covered with the material of body 30 after molding. Mold 60 may itself be fabricated in the conventional manner, for example by casting around a brass outline plug in the desired shape of eventual body 30.

Molding material 62 of body 30 is then injected into mold 60 after the placement of coil drivers 36 and circuit board 38, as shown in FIG. 4c. The particular molding process, either conventional injection molding or transfer molding, depends upon the type of material used for body 30. According to the preferred embodiment of the invention, as noted above, material 62 is a conventional filled epoxy, such as the T905 and T7110 epoxies, in which case transfer molding (i.e., injection molding under pressure) is used. In any event, molding material 62 is cured in the conventional manner appropriate for the specific material, resulting in the formation of body 30 having the desired features, including shelves 32, 34.

As shown in FIG. 4d, mirror element 41 is then attached to body 30, by adhering it to shelf 34 at the top surface. Mirror element 41 is attached to shelf 34 by way of a conventional epoxy or other adhesive substance. Following the attachment of mirror element 41, window 31 is then attached to shelf 32 of body 30 by way of a conventional epoxy adhesive or the like. This completes the fabrication of packaged micromirror assembly 10, as shown in FIG. 4e.

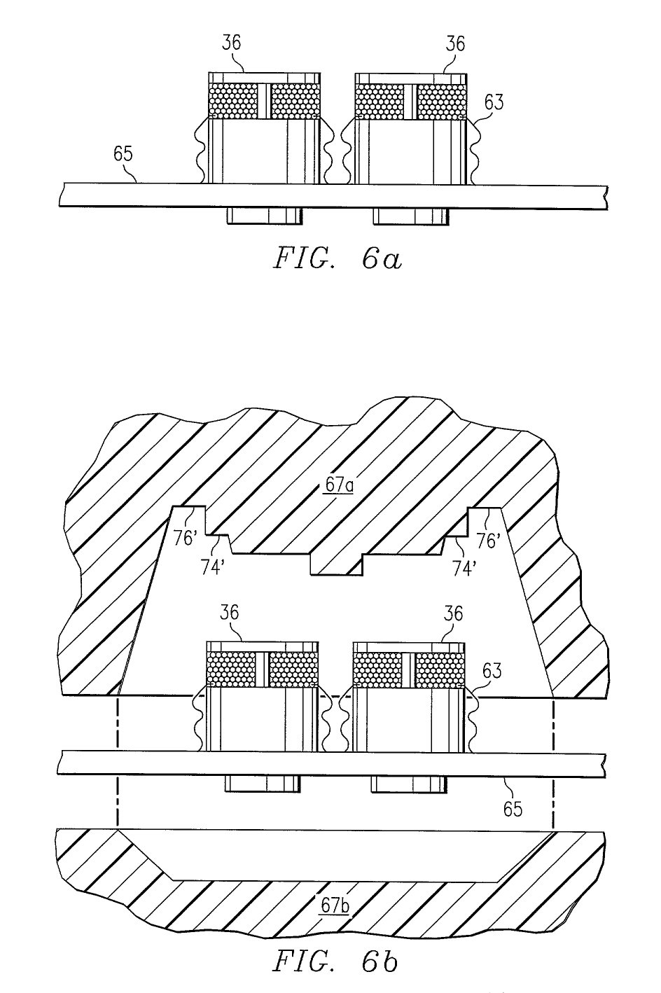

As evident from this description, a relatively low-cost and straightforward method of packaging micromirror assembly 10 is thus provided. The casting process of this first embodiment of the invention is well suited for relatively modest production volumes. According to a second preferred embodiment of the present invention, a higher volume package and method of packaging is provided, as will now be described relative to FIGS. 5a and 5b.

FIG. 5a illustrates packaged micromirror assembly 10′ according to this second embodiment of the invention. Packaged micromirror assembly 10′ includes coil drivers 36, mirror element 41, and window 31, as before. According to this embodiment of the invention, coil drivers 36 are physically mounted and electrically connected to lead frame 65, which is a copper, tin, or palladium-plated lead frame as conventionally used in the packaging of integrated circuits. Lead frame 65 and coil drivers 36 are encased within molded body 70, as shown in FIG. 5a. Molded body 70 is formed of a conventional plastic mold compound as used in the plastic packaging of integrated circuits, such mold compounds being well-known in that art. Molded body 70 has an upper surface with shelves 74, 76, to which mirror element 41 and window 31 are respectively attached. Furthermore, according to this preferred embodiment of the invention, magnet stops (not shown) are also preferably formed in molded body 70 to limit the rotation of mirror 29 and to ensure that magnets 53 contact body 70 without undue twisting, as described above relative to FIGS. 2c and 2d. As shown in FIG. 5a, packaged micromirror assembly 10′ is of the surface mount type, suitable for mounting upon an upper surface of circuit board 72 in the known manner.

FIG. 5b illustrates packaged micromirror assembly 10″ according to a variation of this second preferred embodiment of the invention, in which lead frame 65′ has leads of the single-inline-package (SIP) type. Of course, lead frame 65′ may alternatively be formed into a dual-inline-package (DIP) type. Coil drivers 36, mirror element 41, and window 31 are encased or attached to molded body 70 in the same manner as in packaged micromirror assembly 10′ of FIG. 5a. As shown in FIG. 5b, however, SIP packaged micromirror assembly 10″ is attached to circuit board 72′ by insertion of the leads through holes in circuit board 72′.

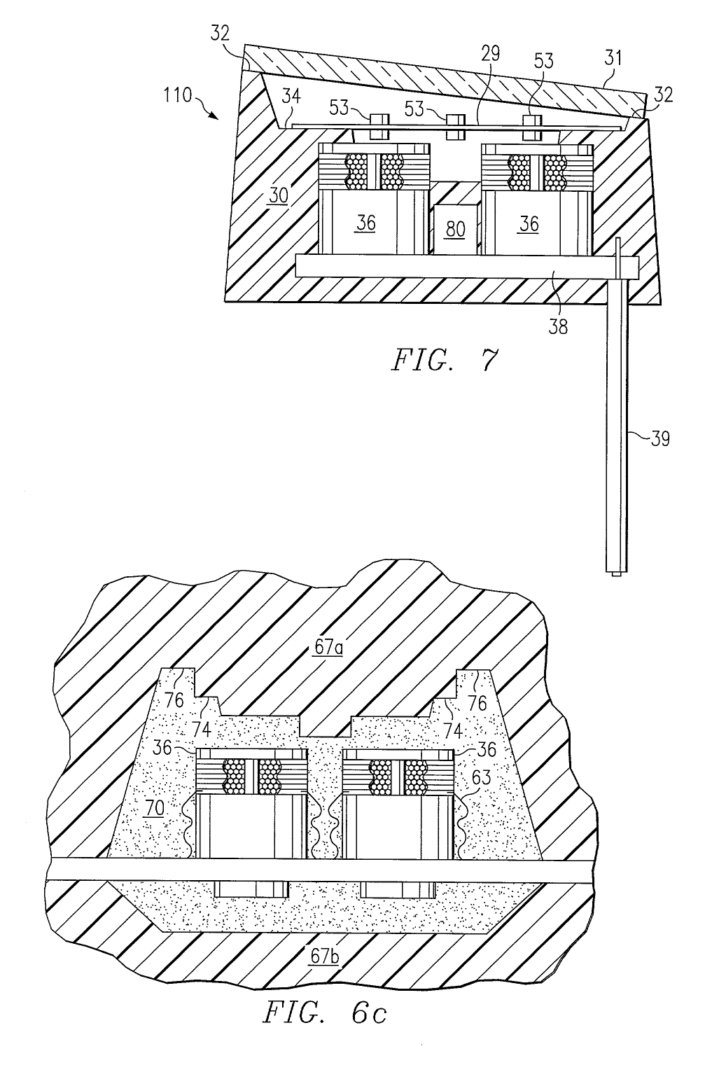

Referring now to FIGS. 6a through 6c, a method of fabricating packaged micromirror assembly 10′ (and assembly 10″) according to this second preferred embodiment of the invention will now be described. As shown in FIG. 5a, coil drivers 36 are physically attached to lead frame 65 by way of an epoxy adhesive or other conventional technique. Wires 63, attached by conventional wire bonding techniques, make electrical connection between coil drivers 36 and leads of lead frame 65.

As shown in FIG. 6b, lead frame 65 with coil drivers 36 are placed between mold halves 67a, 67b, for example in a conventional mold press. Mold halves 67a, 67b are constructed according to the shape and size of molded body 70. In this regard, upper mold half 67a has surfaces 74′, 76′ for defining the location of shelves 74, 76 of molded body 70. Mold halves 74′, 76′ are closed, and mold compound is then injected into the cavity defined by mold halves 67a, 67b to form, after cure, molded body 70 as shown in FIG. 6c. This molding process effectively follows the well-known transfer molding technique used in the packaging of integrated circuits.

Following release of molded body 70 from mold halves 67a, 67b, mirror element 41 and window 31 are then attached to molded body 70, upon shelves 74, 76 respectively. This attachment is effected by way of a conventional epoxy adhesive or the like. Following such attachment of these elements, packaged micromirror assembly 10′, or 10″ in the SIP case, is completed, as shown in FIGS. 5a and 5b, respectively.

This second preferred embodiment of the present invention is particularly advantageous in the high-volume manufacture of micromirror assemblies. This embodiment of the invention utilizes conventional high-volume techniques of component attachment to lead-frames, and transfer molding encapsulation of these lead frames, thus obtaining the high reliability and high yield provided by this mature packaging process. Additionally, as is known in the integrated circuit packaging art, this approach to plastic packaging is extremely inexpensive, with the packaging cost being as low as a few cents per unit. In addition, the resulting packaged micromirror assembly can be of the same form factor as conventional integrated circuit packages, enabling the use of existing integrated circuit packaging equipment for manufacture and circuit board mounting.

Referring now to FIG. 7, packaged micromirror assembly 110 according to a third embodiment of the invention will now be described in detail. In this example, the construction of packaged micromirror assembly 110 follows that of packaged micromirror assembly 10 described above relative to FIGS. 2a and 2b, with like elements referred to by the same reference numerals.

In addition, packaged micromirror assembly 110 according to this embodiment of the invention further includes heater 80, which is mounted to driver circuit board 38 among driver coils 36. In this example, heater 80 is a resistance heater, preferably a self-regulating resistance heater formed of a positive temperature coefficient (PTC) material. In this realization, heater 80 has two electrical connections to corresponding ones of leads 39, to receive the desired level of current.

Heater 80 provides further advantages in the implementation of micromirror assemblies. It is contemplated, as noted above, that transmitter optical modules may be deployed outdoors, to provide optical wireless network communications from building-to-building. In such an outdoor environment, and considering that molded package bodies such as bodies 30, 70 do not hermetically seal their contents, rapid changes in the ambient temperature can cause internal condensation, especially in high humidity environments. Such condensation can, of course, result in malfunction of the micromirror element. The inclusion of heater 80 in packaged micromirror assembly 110 according to this third preferred embodiment of the invention, however, can eliminate such internal condensation, enabling packaged micromirror assembly 110 to function reliably over a wide range of weather conditions.

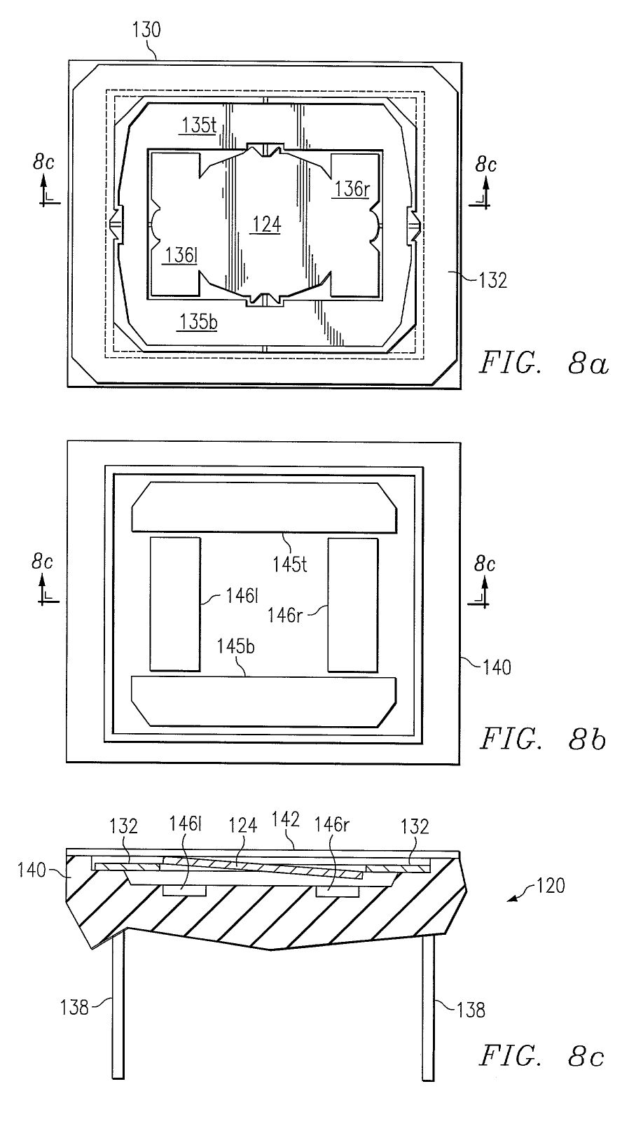

Referring now to FIGS. 8a through 8c, packaged mirror assembly 120 according to another preferred embodiment of the invention will now be described in detail. According to this embodiment of the invention, the positioning of the mirror is driven electrostatically, rather than magnetically as in the previously described embodiments. As is well known in the art, the concept of electrostatic drive is based on the attractive force between oppositely charged objects. It is contemplated that the electrostatic drive is most suitable for those applications in which the overall deflection range of the mirror is relatively small, such as on the order of a few degrees.

Referring now to FIG. 8a, mirror 130 according to this embodiment of the invention will now be described. As shown in FIG. 8a, mirror 130 includes frame 132, which supports mirror element 124 in a gimbaled manner by way of hinges (not shown), as described above. An outer gimbal includes widened portions 135t, 135b, on which electrostatic forces can act to rotate mirror element 124 about the major axis of mirror 130, as will become apparent from this description. An inner gimbal includes widened portions 136l, 136r, on which electrostatic forces can act to rotate mirror element 124 about the minor axis of mirror 130, as will also be described below. Mirror 130 is preferably formed from a single body of single-crystal silicon, as described above, although other multiple-piece construction approaches may alternatively be used to fabricate mirror 130.

FIG. 8b illustrates the position of electrostatic plates 145, 146 within molded package 140. Each of electrostatic plates 145, 146 is positioned within package 140 to be aligned with a corresponding widened gimbal portion 135, 136, respectively, when mirror 130 is mounted to package 140. In this embodiment of the invention, electrostatic plate 145t mates with widened gimbal portion 135t, electrostatic plate 145b mates with widened gimbal portion 135b, electrostatic plate 1461 mates with widened gimbal portion 136l, and electrostatic plate 146r mates with widened gimbal portion 136r. In this arrangement, each of electrostatic plates 145, 146 controllably attracts its corresponding widened gimbal portion 135, 136, responsive to the potential applied to that electrostatic plate 145, 146. Electrostatic plates 145, 146 are preferably formed of conventional conductive material (e.g., Alloy 42), which may be plated if desired, as used in modern plastic molded integrated circuit packages.

FIG. 8c illustrates mirror assembly 120 according to this embodiment of the invention, in which frame 132 of mirror 130 is mounted to molded body 140, within which electrostatic plates 145, 146 are disposed. Protective window 142, which is transparent to the wavelengths of light to be directed by mirror surface 124, is mounted to molded body 140 above mirror 130 as shown. As discussed above, molded body 140 is preferably formed of a conventional integrated circuit package mold compound, about a lead frame or other support for electrostatic plates 145, 146, by way of conventional injection or transfer molding, so that electrostatic plates 145, 146 are exposed at the upper surface of molded body 140. Leads 138 extend from the bottom of molded body 140, and are in electrical connection with electrostatic plates 145, 146 so that the desired electrostatic force can be applied to mirror 130 from electrostatic plates 145, 146. In the example of FIG. 8c, mirror surface 124 is shown as slightly rotated in response to an electrostatic force due to electrostatic plate 146r being biased so as to attract widened gimbal portion 136r of mirror 130.

According to this embodiment of the invention, mirror assembly 120 provides a controllable mirror for the deflection of light, such as in an optical network. The use of electrostatic force rather than magnetic force to control the deflection of the mirror surface provides for a lower cost assembly, both in components and in assembly cost, considering that permanent magnets and coil drivers are not used in mirror assembly 120. Especially considering that a significant source of manufacturing yield loss is due to the attachment of permanent magnets to the fragile mirrors, this embodiment of the invention is contemplated to be attractive for those applications in which the somewhat reduced range of deflection is adequate.

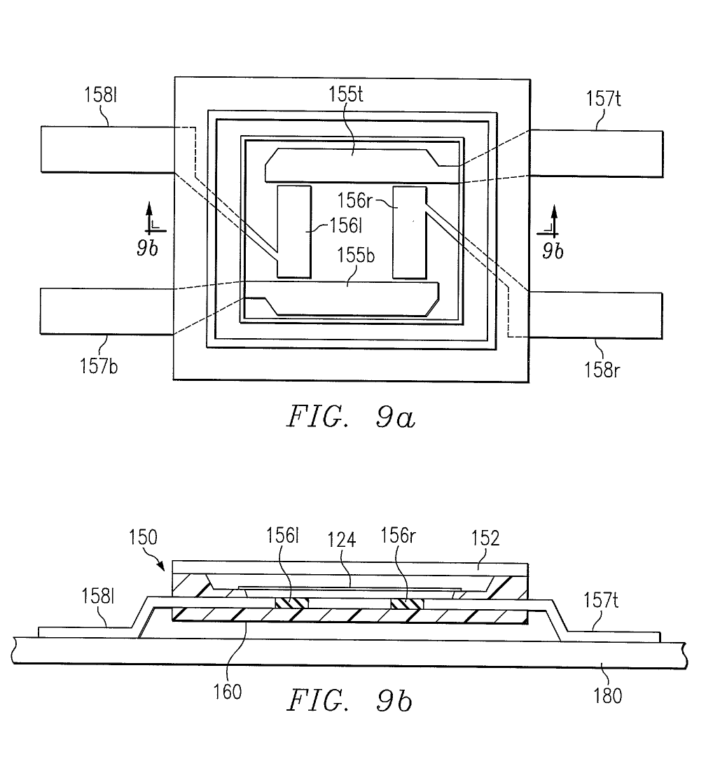

FIGS. 9a and 9b illustrate mirror assembly 150 according to another embodiment of the invention. Mirror assembly 150 also uses electrostatic forces to controllably deflect mirror surface 124. In assembly 150 according to this embodiment of the invention, mirror 130 is identical to that illustrated in FIG. 8a. As shown in FIG. 9a, mirror assembly 150 includes a lead frame in which external leads 157, 158 are formed integrally with their corresponding electrostatic plates 155, 156. As shown in FIG. 9b, molded body 160 surrounds leads 157, 158, and has a surface at which electrostatic plates 155, 156 are exposed as shown in FIG. 9a. Molded body 160 is formed of conventional mold compound, molded about leads 157, 158 by conventional injection or transfer molding. Electrostatic plates 155, 156 are arranged to mate with corresponding widened gimbal portions 135, 136, respectively, when mirror 130 is mounted.

In this embodiment of the invention, lead 157t is at one end of a body that has electrostatic plate 155t at its other end. Similarly, lead 157b is integrally formed with electrostatic plate 155b, lead 158l is integrally formed with electrostatic plate 1561, and lead 158r is integrally formed with electrostatic plate 158r. As is conventional for integrated circuit lead frames, the bodies forming leads 157, 158 and electrostatic plates 155, 156 are typically stamped or etched into a lead frame with all of the bodies interconnected prior to molding; following the molding of the package about the leads 157, 158, the connecting tie bars are trimmed so that each lead is electrically isolated from the others, as is well known in the art.

FIG. 9b illustrates mirror assembly 150 in cross-section, after its attachment to a printed circuit board 180. Leads 157, 158 are thus in connection with circuit board conductors (not shown) that serve to control the deflection of mirror surface 124 within molded body 160, according to the bias applied to their respective electrostatic plates 145, 146. Protective transparent window 152 is mounted to provide environmental protection for mirror 130, while being transparent to the light being deflected thereby.

As in the embodiment of FIGS. 8a through 8c, the molded mirror assembly 150 according to this embodiment of the invention is contemplated to provide a lower cost assembly, because the electrostatic deflection of the mirror eliminates the need to attach permanent magnets to the mirror and the need to embed coil drivers in the molded package. Surface-mount attachment of the mirror assembly 150 to a circuit board 180 is also facilitated by this embodiment of the invention.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

We claim:

1. A packaged mirror assembly, comprising:
a mirror element having a frame, a mirror surface, and a plurality of hinges;
a plurality of drive elements, for controlling deflection of the mirror element responsive to electrical signals; and
a molded plastic body encasing the plurality of drive elements, and to which the mirror element is attached, the plurality of drive elements having electrical connections through the plastic body.

2. The assembly of claim 1, wherein the mirror element is formed of a single piece of crystalline material.

3. The assembly of claim 1, further comprising at least one permanent magnet attached to the mirror element;
and wherein the plurality of drive elements comprises:
a plurality of coil drivers, encased by the molded plastic body to be in proximity to the at least one permanent magnet, for orienting the mirror element responsive to electrical signals applied to the electrical connections.

4. The assembly of claim 1, further comprising:
a transparent window, attached to the molded plastic body in such a manner that the mirror element is located within a cavity formed by the molded body and the window.

5. The assembly of claim 4, wherein the molded body has an inner shelf to which the mirror element is attached;
and wherein the molded body has an outer shelf to which the window is attached.

6. The assembly of claim 5, wherein the molded body has a plurality of stops at an upper surface, for limiting the rotation of the mirror element.

7. The assembly of claim 6, wherein at least one of the stops are impacted by one of the magnets at a limiting position of the mirror element;
and wherein the limiting position of the mirror element is reached without the mirror impacting the transparent window.

8. The assembly of claim 1, wherein the molded body has an inner shelf to which the mirror element is attached;
and wherein the molded body has a plurality of stops at an upper surface, for limiting the rotation of the mirror element.

9. The assembly of claim 3, further comprising:
a circuit board, to which the plurality of coil drivers is attached; and
a plurality of pins attached to the circuit board, extending through the molded body, and electrically connected to the plurality of coil drivers.

10. The assembly of claim 1, further comprising:
a lead frame to which the plurality of drive elements is attached, the lead frame having a plurality of leads extending through the molded body, said leads electrically connected to the plurality of drive elements.

11. The assembly of claim 10, wherein the leads are of the surface-mount type.

12. The assembly of claim 10, wherein the leads are of the through-hole type.

13. The assembly of claim 1, further comprising:
a resistance heater, encased by the molded plastic body.

14. The assembly of claim 1, wherein the plurality of drive elements comprise electrostatic plates, for applying electrostatic forces to corresponding portions of the mirror element.

15. A method of packaging a mirror assembly, comprising the steps of:
physically and electrically attaching a plurality of drive elements to a member having a plurality of external connectors;
molding a plastic body around said plurality of coil drivers and at least a portion of the member, the plastic body having a first shelf; and
attaching, to the first shelf of the plastic body, a mirror element formed of a single piece of crystalline material, the mirror element having a frame, a mirror surface, and a plurality of hinges.

16. The method of claim 15, wherein the plurality of drive elements are coil drivers;
and further comprising:
attaching at least one permanent magnet to the mirror element.

17. The method of claim 15, wherein the plastic body also has a second shelf;
and further comprising the step of:
attaching a transparent window to the second shelf of the plastic body, so that the mirror element is disposed between the window and the plastic body.

18. The method of claim 15, wherein the plastic body has a plurality of stops at an upper surface, for limiting the rotation of the mirror element.

19. The method of claim 15, wherein the molding step comprises:
placing the member into a mold, the mold having surfaces defining the first and second shelves; and
injecting plastic into the mold to form the plastic body.

20. The method of claim 19, wherein the member is a circuit board having pins attached thereto;
and wherein the injecting step comprises casting plastic into the mold to surround the circuit board.

21. The method of claim 15, wherein the member is a lead frame having a plurality of leads;
and wherein the molding step comprises:
placing the lead frame into a mold cavity having upper and lower halves, the upper half having surfaces defining the first shelf; and
molding the plastic body to surround at least a portion of the lead frame.

22. The method of claim 15, wherein the plurality of drive elements comprises a plurality of electrostatic plates, and wherein the plurality of electrical connectors comprises a plurality of external leads, each attached to a corresponding one of the plurality of electrostatic plates.
